(19) United States
(12) Patent Application Publication
(10) Pub. No.: US 2005/0162994 A1
(43) Pub. Date: Jul. 28, 2005

(54) Two-wavelength optical element

(76) Inventor: Masato Inagaki, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/506,030

(22) PCT Filed: Jun. 3, 2003
(86) PCT No.: PCT/JP03/07020

(30) Foreign Application Priority Data
Jun. 3, 2002 (JP) 2002-160918

(51) Int. Cl. G11B 7/00

(52) U.S. Cl. 369/44.12; 369/121

(57) ABSTRACT

By obtaining a two-wavelength optical device which can cancel the optical-path difference due to the difference of the wavelengths occurred when two wavelength elements are integrated in one unit, the deterioration of a reproduction signal of an optical disk which may be produced by the optical-path difference is suppressed. In a two-wavelength optical device (1) for reading from and writing to an optical disk and including a plurality of light emitting elements (3), (5) for emitting laser lights (17) having different wavelengths to the optical disk, and a light receiving element (13) for receiving a return light from the optical disk, the respective light emitting elements (3), (5) are arranged at relative positions where the optical-path difference appears due to the difference between the different wavelengths, is cancelled.

### TECHNICAL FIELD

The present invention relates to a two-wavelength optical device provided with a plurality of light emitting elements for emitting laser beams having different wavelengths toward an optical disk, making a change of the returned light strike a light receiving element, and outputting the result as an optical disk reproduction signal.

### BACKGROUND ART

A device using an optical recording medium such as a compact disk (CD) player and a digital versatile disk (DVD) device uses a laser beam of the 780 nm band wavelength for playing a CD and uses a laser beam of the 650 nm band wavelength for playing a DVD, therefore different optical disk devices have been used for reading (reproducing) information recorded on the optical disk and writing (recording) information on to the same. In recent years, two-wavelength optical devices producing laser beams of wavelengths differing according to the type of the optical disk by single optical pick-ups have been marketed.

Such a two-wavelength optical device has a light emitting element (first laser diode) for emitting a laser beam having a wavelength of the 780 nm band, a light emitting element (second laser diode) for emitting a laser beam having a wavelength of the 650 nm band, a light receiving element for receiving returned light emitted from these light emitting elements to the optical disk and outputting an optical disk reproduction signal, a grating arranged at a predetermined position of a light path between the light emitting elements and the light receiving element, a mirror, a lens, and other parts of an optical system. Note that, in the above optical system, parts of the optical members are shared for the light emitting elements.

In a two-wavelength optical device configured in this way, the laser beam from each light emitting element passes through the grating, is deflected in its advance path by the mirror, and is focused onto the optical disk by the lens. The returned light from the optical disk is made to strike the light emitting element via the lens, mirror, etc. The information recorded on the recording surface of the optical disk is read by the change of this returned light. In this way, in a two-wavelength optical device, by mounting a CD use laser diode and a DVD use laser diode and sharing the optical system, playing back both a CD and a DVD is possible.

However, since the conventional optical disk reading and writing use two-wavelength optical device described above differs in the wavelengths of the light emitted from the light emitting elements, that is, 780 nm and 650 nm and in addition share the optical system, the lengths of light paths up to the light emitting elements and the light receiving element become relatively different and therefore a light path difference occurred. That is, the focal deviation caused by the focal deviation becomes about 180 μm as a theoretical value in an actual device having the above configuration. In the past, the light path difference occurring due to such a difference of the two different wavelengths had been adjusted by the difference of the thickness of the light receiving element receiving the returned light from the optical disk and the thickness of a semiconductor wafer (sub mount) serving as the base for arrangement of the light emitting elements.

However, it is extremely difficult in terms of processing precision to obtain a thickness adjusting the light path difference, found as a theoretical value, by the thickness of the light receiving element and machining of the mount thickness. There was a problem that the device was actually used with the light path difference remaining and therefore the optical disk reproduction signal deteriorated.

### DISCLOSURE OF THE INVENTION

The present invention has as its object to provide a two-wavelength optical device able to cancel the light path difference due to the wavelength difference occurring when forming a two-wavelength optical device and to suppress deterioration of the optical disk reproduction signal occurring due to a light path difference.

To attain the above object, the two-wavelength optical device according to the present invention is a two-wavelength optical device, for reading and/or writing data from/to an optical disk, provided with a plurality of light emitting elements for emitting laser beams having different wavelengths toward an optical disk and a light receiving element for receiving the returned light from said optical disk, characterized in that said light emitting elements are arranged at relative positions for canceling a light path difference occurring due to the difference of the two different wavelengths.

In this two-wavelength optical device, the light emitting elements are arranged at relative positions for canceling the light path difference occurring due to the difference of wavelengths. Namely, even in a case where for example a CD use laser diode for emitting a laser beam having a wavelength of the 780 nm band and a DVD use laser diode emitting a laser beam having wavelength of the 650 nm band share one optical system, a relative difference of light paths disappears and cancellation of most of the light path difference becomes possible. Due to this, focal deviation occurring due to the light path difference is eliminated and deterioration of the optical disk reproduction signal occurring due to the light path difference is suppressed.

Further, the two-wavelength optical device of the present invention provides the above two-wavelength optical device characterized in that one of said light emitting elements is arranged so that a light emitting point is located at an upper side from the center of thickness in the laser beam emitting direction and the other of said light emitting elements is arranged so that the light emitting point is located at a lower side from the center of thickness of the laser beam emitting direction.

In the two-wavelength optical device, adjustment of the light emitting point of the light emitting element becomes possible in the thickness direction of the laser beam emitting direction. Namely, adjustment of the light emitting point becomes possible in the optical axis direction. For this reason, the movement distance directly acts upon the adjustment distance of the focal point, so effective adjustment of focal deviation becomes possible.

Further, the two-wavelength optical device of the present invention provides the above two-wavelength optical device characterized in that one light emitting element is vertically inverted to position said light emitting point at the upper side from the center of thickness in the laser beam emitting direction.

In this two-wavelength optical device, in the case of a light emitting element having a light emitting point located at the upper side or the lower side from the center of thickness in the laser beam emitting direction, by vertically inverting the light emitting element, adjustment of the position of the light emitting point in the optical axis direction easily becomes possible without machining etc.

Further, the two-wavelength optical device of the present invention provides the above two-wavelength optical device characterized in that said light emitting elements are arranged moved along the top of a mount surface to relative positions for canceling the light path difference.

In this two-wavelength optical device, by arranging the light emitting elements moved along the top of the mount surface, cancellation of the light path difference becomes possible. In this case, the movement distance indirectly acts upon the adjustment distance of the focal point, therefore, unlike a case where the light emitting point is adjusted in the thickness direction of the laser beam emitting direction, that is, the optical axis direction, the adjustment distance becomes small, so fine adjustment of the focal deviation can be made possible.

### BRIEF DESCRIPTION OF THE DRAWINGS

FIG. 1 is a cross-sectional view of the general configuration of a two-wavelength optical device according to the present invention.

FIG. 2 is a plan view of principal parts of the two-wavelength optical device shown in FIG. 1.

FIGS. 3A, 3B, and 3C are explanatory views of light emitting points of light emitting elements.

### BEST MODE FOR WORKING THE INVENTION

Below, a preferred embodiment of the two-wavelength optical device according to the present invention will be explained in detail with reference to-the accompanying drawings.

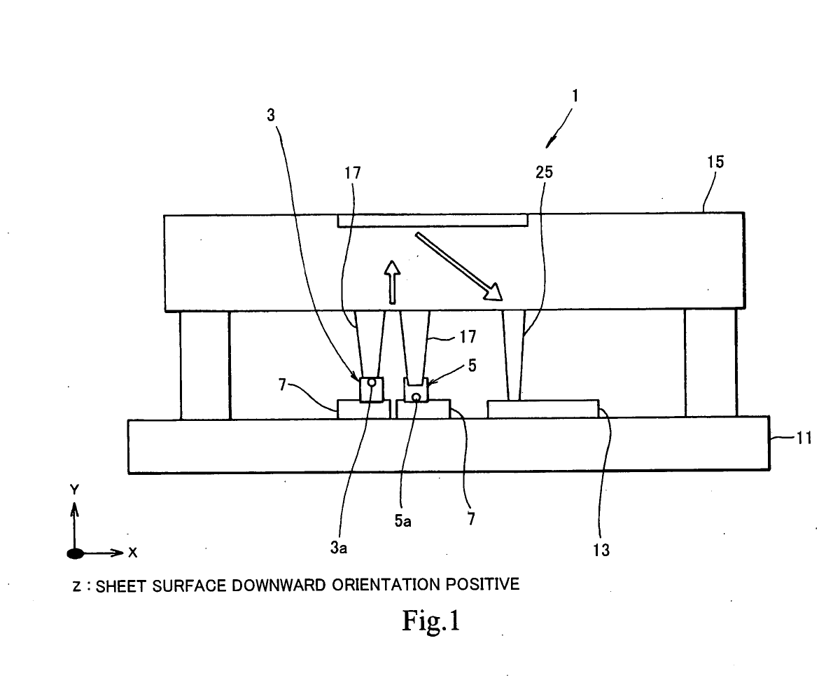

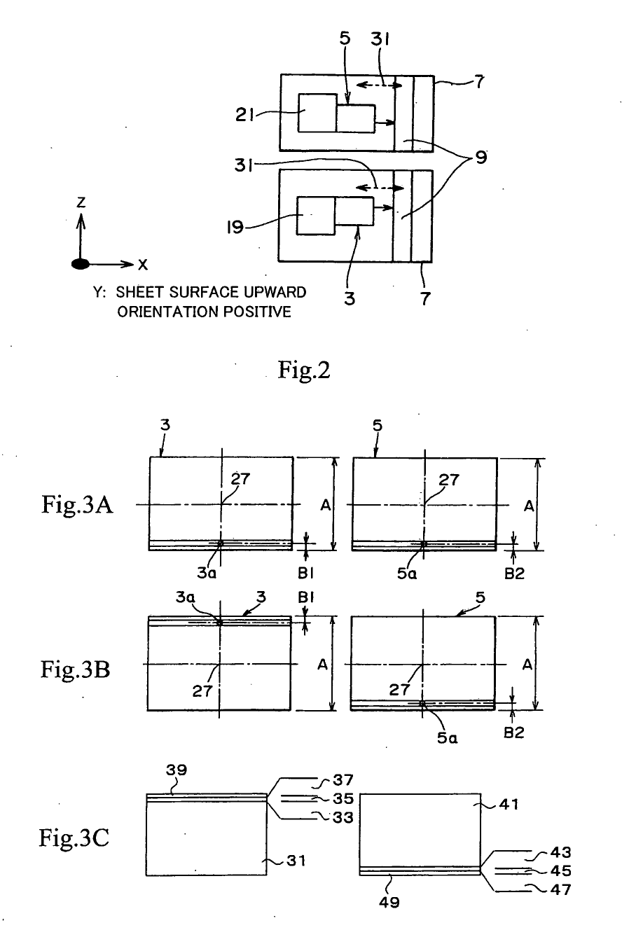

FIG. 1 is a cross-sectional view of the schematic configuration of a two-wavelength optical device according to the present invention; FIG. 2 is a plan view of principal parts of the two-wavelength optical device shown in FIG. 1; and FIGS. 3A, 3B, and 3C are explanatory views of light emitting points of light emitting elements.

The two-wavelength optical device 1 according to the present embodiment has a plurality of (two in the present embodiment) light emitting elements (laser diodes) 3 and 5 emitting laser beams having different wavelengths arranged in parallel on a semiconductor wafer (hereinafter, referred to as a sub mount 7) which becomes the base. One light emitting element 3 emits for example a laser beam having the 780 nm band wavelength for a compact disk (CD), while the other light emitting element 5 emits a laser beam of the 650 nm band wavelength for the digital versatile disk (DVD).

The sub mount 7 is chemically processed to form a rising mirror 9 shown in FIG. 2. The sub mount 7 is arranged on a package 11. The package 11 is provided with a light receiving element 13 arranged adjacent to the sub mount 7. The light receiving element 13 receives the returned light from a not illustrated optical disk, converts the change of the returned light to an electric signal, amplifies an output signal, and outputs it to outside the package 11. At an upper portion of the package 11 housing these light emitting elements 3 and 5 and the light receiving element 13, an optical element (for example a hologram or a lens) 15 is arranged. The optical element 15 is fixed by bonding to the reference surface on the package 11 after optically positioning.

The rising mirror 9 is comprised of a semiconductor wafer having a certain thickness etched so that a slope of 45 degrees appears and coated on the surface with a high reflection film (for example refractive index R=99.9%). Behind the laser beam emitting positions of the light emitting elements 3 and 5 (leftward in the X-axis direction of FIG. 2), light receiving surfaces 19 and 21 of a monitor use light receiving element are formed. By constantly monitoring the outputs of the two light emitting elements 3 and 5 by the monitor use light receiving element, APC (automatic power control) is carried out so that the outputs of the light emitting elements 3 and 5 become constant and the drive current is controlled. The light emitting elements 3 and 5 are selectively used according to the type (CD or DVD) of the mounted optical disk.

Here, an explanation will be given of the light paths of the two-wavelength optical device 1 having such a configuration.

Laser beams 17 emitted from the light emitting elements 3 and 5 advance on the X-axis 31 of FIG. 1 and are bent (deflected) by 90 degrees in a Y-axis direction in the figure by the rising mirror 9 formed on the sub mount 7. The light bent by the rising mirror 9 passes through the optical element 15 arranged on the package 11, passes through a not disclosed collimator lens and object lens arranged on an optical pick-up (OP), and is focused on a not illustrated optical disk.

The returned light reflected from the optical disk surface passes through the object lens and the collimator lens and strikes the optical element 15 disposed on the package 11. The laser beam 17 striking the optical element 15 is divided in light path by the grating lattice, lens, etc. formed on the surface. The divided light becomes the returned light 25 and strikes the light receiving element 13 arranged inside the package 11. The light receiving element 13 amplifies and outputs the optical disk reproduction signal and the control signal necessary for the OP actuator control.

However, the light emitting elements 3 and 5 are arranged at relative positions for canceling the light path difference occurring due to the difference of the two different wavelengths.

As shown in FIG. 3A, the light emitting elements 3 and 5 have light emitting points 3a and 5a located at the lower side from the center of thickness 27 in the laser beam emitting direction. For example, in the case of light emitting elements 3 and 5 having a thickness A of 120 to 180 μm, the compact disk (CD) use light emitting element 3 has the light emitting point 3a at a position of B1=2.3 μm from the bottom surface. Further, the digital versatile disk (DVD) use light emitting element 5 has the light emitting point 5a at a position of B2=1.2 μm from the bottom surface.

In such light emitting elements 3 and 5 having light emitting points 3a and 5a offset (deviated) from the center of thickness 27, as the mode of canceling the light path difference by the relative positions of the light emitting elements 3 and 5, arrangement of one of the light emitting elements 3 and 5 so that the light emitting point is located at the upper side from the center of thickness 27 in the laser beam emitting direction and arrangement of the other of the light emitting elements so that the light emitting point is located at the upper side from the center of thickness 27 in the laser beam emitting direction can be mentioned. In this case, the adjustment of the light emitting points 3a and 5a of the light emitting elements 3 and 5 becomes possible in the thickness direction in the laser beam emitting direction. Namely, the adjustment of the light emitting points 3a and 5a becomes possible in the optical axis direction, therefore, the movement distance directly acts upon the adjustment distance of the focal point and effective adjustment of the focal deviation becomes possible.

Such a positional relationship between the light emitting points 3a and 5a can be realized by vertically inverting one light emitting element 3 to vertically invert the light emitting point 3a with respect to the center of thickness 27 of the laser beam emitting direction as shown in FIG. 3B. Namely, the light emitting element 5 has the light emitting point 5a arranged so as to be located on the solder and silver paste bonding surface side of the sub mount 7 (hereinafter referred to as the “junction down”), while the other light emitting element 3 is arranged so that the light emitting point 3a is located at the upper side (opposite side to the bonding surface) (hereinafter referred to as the “junction up”).

More concretely, the light emitting element 3 and the light emitting element 5 are prepared as shown in FIG. 3C. In the case where the light emitting element 3 is an AlGaAs-based semiconductor laser having the 780 nm band wavelength for a CD, for example, it is comprised of an n-type GaAs substrate 31 on which a first clad layer constituted by an n-type AlGaAs layer 33, an AlGaAs active layer 35, and a second clad layer constituted by a p-type AlGaAs layer 37 are epitaxially grown and over which a p-type electrode 39 is formed via a contact layer, etc. The GaAs substrate 31 is for example 450 μm at the time of the crystal growth, but in order to facilitate cleaving for the formation of an oscillator end face of the semiconductor laser, the thickness is reduced from 80 μm to about 200 μm, typically to for example about 180 μm, by lapping after the crystal growth.

In the same way, in a case where the light emitting element 5 is an AlGaInP-based semiconductor laser having the 650 nm band wavelength for a DVD, for example, it is comprised of an n-type GaAs substrate 41 on which a first clad layer constituted by an n-type AlGaP layer 43, an active layer 45 made of GaInP, and a second clad layer constituted by a p-type AlGaP layer 47 are epitaxially grown and further over which a p-type electrode 49 is formed via a contact layer etc. The GaAs substrate 41 is made thin by lapping so as to obtain a predetermined thickness in the same way as the light emitting element 3. The light emitting element 5 is mounted so that the substrate side becomes at the top, that is, the crystal growth layer side faces downward.

The difference of the height between the light emitting point 3a of the light emitting element 3 and the light emitting point 5a of the light emitting element 5 becomes for example 180 μm or substantially matching the 180 μm of the light path difference between the light emitting elements 3 and 5.

By employing a mode of vertically inverting one of the light emitting points 3a and 5a to vertically invert the light emitting point with respect to the center of thickness 27 in the laser beam emitting direction in this way, adjustment of the position of the light emitting point in the optical axis direction easily becomes possible without machining etc.

Due to this, the interval of the positions of the light emitting points 3a and 5a of the light emitting elements 3 and 5 can be set to 120 to 180 μm in the light path direction (when using a visible ray laser and an infrared ray laser as the laser), therefore the light path difference can be cancelled. That is, the focal deviation of 180 μm of the theoretical value which occurred in an actual device can be eliminated.

Above, the case where the light emitting element 3 and the light emitting element 5 were an AlGaAs-based semiconductor laser having the 780 nm band wavelength for a CD and an AlGaInP-based semiconductor laser having the 650 nm band wavelength for a DVD was explained, but the present invention is not limited to a combination of these semiconductor lasers. Namely, in the present invention, it is sufficient that there be a combination of semiconductor lasers having different wavelengths. For example, it may be a GaN-based semiconductor laser having a 405 nm band wavelength and an AlGaInP-based semiconductor laser having a 650 nm band wavelength. Further, it may also be a combination of for example a GaN-based semiconductor laser having a 405 nm band wavelength and a AlGaAs-based semiconductor laser having a 780 nm band wavelength.

Further, as the mode of canceling the light path difference by the relative positions of the light emitting elements 3 and 5, arrangement of the light emitting elements 3 and 5 by moving them along the mount surface (sub mount 7) to relative positions canceling the light path difference can be mentioned. Namely, by arrangement by movement of the light emitting elements 3 and 5 along the top of the mount surface, cancellation of the light path difference becomes possible. In this case, the movement distance indirectly acts upon the adjustment distance of the focal points, therefore, unlike the case of adjusting the light emitting points 3a and 5a in the thickness direction in the laser beam emitting direction, that is, the optical axis direction, the adjustment distance becomes small, therefore fine adjustment of the light path difference becomes possible. Due to this, fine adjustment of the focal deviation becomes possible, and it becomes possible to suppress deterioration of the optical disk reproduction signal to the lowest limit.

According to the two-wavelength optical device 1, the light emitting elements 3 and 5 are arranged at relative positions for canceling the light path difference occurring due to the difference of wavelengths. Namely, one of the light emitting elements 3 and 5 is arranged junction up, and another one is arranged junction down. Accordingly, even in a case where for example the CD use laser diode for emitting a laser beam having the 780 nm band wavelength and the DVD use laser diode for emitting a laser beam having the 650 nm band wavelength share a single optical system, the relative difference of the light paths is eliminated and cancellation of almost all of the light path difference becomes possible. By this, the focal deviation occurring due to the light path difference is cancelled, and the deterioration of the optical disk reproduction signal occurring due to the light path difference can be suppressed.

Further, fine adjustment of the light path difference between the light emitting elements becomes possible by arranging the two light emitting elements 3 and 5 offset to the front and back (in the direction of the arrows 31 of FIG. 2), therefore cancellation of the light path difference can also be easily realized by adjustment of the production system.

Note that in the present embodiment, the explanation was given of an integrated optical device where the light emitting elements 3 and 5 and the light receiving element 13 were integrally formed, but the present invention can be similarly applied to a device configured by only a two-wavelength optical device not having the light receiving element 13 and exhibits the same effects as those described above.

As explained in detail above, according to the two-wavelength optical device according to the present invention, there is provided a two-wavelength optical device provided with a plurality of light emitting elements for emitting laser beams having different wavelengths and a light receiving element for receiving the returned light from the optical disk, wherein the light emitting elements are arranged at relative positions for canceling the light path difference occurring due to the difference of two different wavelengths, therefore most of the light path difference can be cancelled, and the deterioration of the optical disk reproduction signal occurring due to the light path difference can be suppressed.

1. A two-wavelength optical device used for reading data recorded on an optical disk and/or writing data onto said optical disk by focusing two types of light having different wavelengths from two semiconductor laser light emitting elements to said optical disk via a common optical system including a rising mirror deflecting incident light by 45 degrees to emit it oriented to said optical disk,
said two-wavelength optical device characterized by:
canceling a light path difference in said light path optical system caused by a wavelength difference of the two types of laser beams from said two semiconductor laser light emitting elements passing through said light path optical system for said two semiconductor laser light emitting elements by, based on the case where there is no light path difference,
arranging a light emitting portion of a first semiconductor laser light emitting element for emitting a laser beam having a wavelength making said light path difference shorter so as to be located at a lower side from a center of thickness in the laser beam emitting direction of the first semiconductor laser light emitting element and
arranging the light emitting portion of a second semiconductor laser light emitting element for emitting a laser beam having a wavelength making said light path difference longer so as to be located at an upper side from the center of thickness in the laser beam emitting direction of the second semiconductor laser light emitting element.

2. A two-wavelength optical device as set forth in claim 1, characterized by vertically inverting one of the semiconductor laser light emitting elements with respect to a mount surface of said two semiconductor laser light emitting elements to position said light emitting point at the upper side from the center of thickness in the laser beam emitting direction of one semiconductor laser light emitting element.

3. A two-wavelength optical device as set forth in claim 2, characterized by arranging positions of the light emitting portions of said two semiconductor laser light emitting elements at relative positions canceling said light path difference by moving them along the top of the mount surface of said semiconductor laser light emitting elements.

4. A two-wavelength optical device as set forth in any one of claims 1-3, characterized by providing in the vicinity of the positions where said two semiconductor laser light emitting elements are mounted, one light receiving element (13) for receiving the returned light from said optical disk via said light path optical system.

5. An optical pick-up provided with:
two or one rising mirror (9, 9) mounted on two sub mounts having the same height or the same sub mount (7, 7) and
two light emitting elements (3, 5) for emitting two lights having different wavelengths to said rising mirrors in said rising mirrors (9, 9), and
focusing the emission light from one light emitting element selectively driven and selected between said two light emitting elements to a rising mirror, deflecting and focusing the incident light via a shared light path optical system to an optical disk by said rising mirror, and reading the data stored on said optical disk and/or writing the data onto said optical disk, wherein
said light emitting elements are semiconductor laser light emitting elements having substrates (31, 41) and light emitting portions (33, 35, 37; 43, 45, 47) formed on the substrates and emitting emission lights toward said rising mirrors, and
height direction positions of the light emitting portions of said semiconductor laser light emitting elements with respect to said sub mount are adjusted in accordance with the wavelengths of the emitted lights of the two semiconductor laser light emitting elements so as to cancel the light path difference in said light path optical system produced due to wavelengths of the two types of lights having different wavelengths emitted from said two semiconductor laser light emitting elements.

6. An optical pick-up as set forth in claim 5, wherein
the light emitting portion of the first semiconductor laser light emitting element for emitting a laser beam having a wavelength making said light path difference shorter is located at said sub mount side, and
the substrate of the second semiconductor laser light emitting element for emitting the laser beam having the wavelength for making said light path difference long is located at the sub mount side.

7. An optical pick-up as set forth in claim 6, wherein
said light path difference is cancelled by adjusting a thickness of the substrate of either of the two semiconductor laser light emitting elements.

8. An optical pick-up as set forth in any one of claims 5 to 7, wherein
one light receiving element (13) for receiving the returned light from said optical disk via said light path optical system is provided in the vicinity of said sub mount on which said light emitting elements are mounted.
